(19) United States
(12) Patent Application Publication
(10) Pub. No.: US 2005/0256812 A1
(43) Pub. Date: Nov. 17, 2005

(54) Method and system for collecting and processing qualified and unqualified pre-sorted rated mail and courier envelopes and packages using a multi-use drop box system

(76) Inventor: James A. L. Yuill, Rockville, MD (US)

Correspondence Address: Donald A. Kettlestrings, Suite 211, 414 Hungerford Drive, Rockville, MD, 20850, US

(21) Appl. No.: 11/120,078

(22) Filed: May 3, 2005

Related U.S. Application Data
(60) Provisional application No. 60/570,185, filed on May 13, 2004.

(51) Int. Cl. G06F 17/00

(52) U.S. Cl. 705/402

(57) ABSTRACT

A method and system for collecting and processing pre-sorted mail, courier envelopes and small packages and non-metered mail using a multi-use drop box. A single drop box system is used to receive pre-sorted mail that is pre-posted with the pre-sort rate by the customer. These customers may be either qualified or unqualified for a pre-sort rate but the pre-sort mail will be pooled together by the operator and processed by a pre-sort mailing company. Multi-use drop boxes are placed in convenient locations for the customers that are using the services provided by the multi-use drop box system. The multi-use drop boxes are collected from on a scheduled basis by the operator. The operator opens the multi-use drop box and separates the courier envelopes and packages from the pre-sort mail and sorts each into separate holding containers for each company. The separate containers are then delivered to a central facility of the pre-sort mail bureau and a central facility for each courier company. Revenues are received by the operator from the courier companies for pieces delivered to their central facility, and revenues are received by the operator from the pre-sort mail company for pre-sorted mail delivered to their central facility by the operator.

### CROSS REFERENCE TO RELATED APPLICATIONS

This application claims the benefit of U.S. provisional application No. 60/570,185, filed May 13, 2004.

### BACKGROUND OF THE INVENTION

This invention relates to a sorting and processing method and system, and more particularly to providing an economical method for pre-sort bureaus or companies to collect and pool pre-sort mail so that individual unqualified pre-sort rate customers can benefit from the discount rates offered by the U.S. Postal Service (USPS). The invention also provides an economical method for small courier companies to benefit from use of conveniently placed drop boxes for their customers.

Postal rates for mailing letters, flats and parcels through the USPS have been increasing over the last few years. With all the mail received by the postal system there are certain types of mail that require more time to sort and handle and there are other types that are able to be automated to reduce the cost of handling and sorting.

The U.S. Postal Service has offered a special rate for all first class “pre-sort mail”, which is mail that has been pre-sorted based on the zip code system. This pre-sorted mail is able to be processed much more efficiently than mixed mail and therefore the USPS can offer a reduced rate to companies or customers that pre-sort their mail before entering it into the postal system.

With the introduction of these “pre-sort rates” the private sector was able to offer a service to the public by opening pre-sort bureaus or companies that process the mail and submit it to the postal system. The customer could reduce the cost of postage on their mail by posting it with a lower pre-sort rate, and the pre-sort bureau or company would process the mail by zip code for the USPS. The pre-sort bureau would then receive a fee from the USPS for sorting the mail by the zip code, thus reducing the USPS need to process most of this mail which could in most cases be sent directly to the zip code for delivery by the carrier.

The pre-sort companies have been a high growth sector in the mailing industry. They have been able to increase the efficiency of the postal system by pre-sorting mail for the USPS and save money for customers that use their services to process mail.

However, the pre-sort companies have been faced with the same problem as the USPS. They cannot collect small volumes or unqualified pre-sort customers' mail as it is too costly to recover their collection or pickup costs with these small volumes. In most cases they must pay a delivery or pickup company more than they would receive in revenue from the USPS to sort these small volumes. The USPS currently requires that a customer must have from 250 to 500 pieces of mail to receive a pre-sort rate. Therefore, these unqualified smaller businesses or individuals cannot receive the reduced rates as there is no economical or efficient method to pool or collect these smaller volumes for the pre-sort companies. This has effectively locked this market out of the pre-sort rate discounts.

It is this void in the current system that shows an obvious need to supply an economical method of collecting from these unqualified pre-sort volume customers. These customers who cannot meet the minimum requirements for a pre-sort rate have no current method to save money on their postal costs. It is with this observation of the void in the system, that the invention of the multi-use drop box system was developed.

The post office is currently reducing the number of mail boxes in its system, as it is not cost effective for them, and is asking customers to deliver their mail to more central boxes or directly to the post office. The time and money involved with delivering mail to the post office causes an added cost to small businesses.

Large national and international courier companies provide drop boxes for their customers so that they can efficiently control their operations in maximizing the areas they can service for their customers. It is more efficient for one driver to pickup from a single drop box in an office tower than to physically go to each floor and office to pick up each letter or package.

Smaller courier companies and messenger companies are commonly unable to place drop boxes for their customers as the cost is too large and the revenue they receive for an overnight envelope delivered in a local market is less than that of a national courier.

Combining the use and offering multiple services with a single drop box spreads the cost out more efficiently and would allow all parties to benefit from a multi-use drop box system as well as the general public who would be able to use these services and receive discounts by being able to use pre-sort mail rates.

It is with this background of the facts that it is clear there is a large void in the system. The collecting of pre-sort mail and courier envelopes using a multi-use drop box system would open a new market and benefit the public and economy by providing an efficient economical method to collect and process unqualified pre-sort mail customers.

It is, therefore, an object of the present invention to provide a method and system for collecting and processing qualified and unqualified pre-sorted rated mail.

Another object of the present invention is to provide such a method which also collects and processes courier envelopes and packages.

Still another object of the invention is to provide a cost effective method for pre-sort bureaus or companies to offer a pre-sort rate to businesses and individuals that are currently not able to participate in pre-sort rates as there is currently no cost effective method being offered publicly or privately that services this market of small unqualified pre-sort mail users in the mailing or shipping sectors within the U.S.A.

It is another object of the invention to supply a cost efficient method for small courier companies to access a drop box system for their use and to offer such a service to their customers.

It is another object of the invention to provide a system and method whereby small businesses and/or individuals can receive lower postal rates by gaining access to a pre-sort mail service.

It is another objective of the invention to create a new market that pre-sort bureaus or companies can access and to offer discounted postal rates to these markets.

It is another objective of the invention to provide a single drop box that will offer multiple services to a market that is currently not being serviced publicly or privately.

It is another objective of the invention to provide these multi-use drop boxes at locations that are accessible to businesses and individuals that are not currently able to benefit from pre-sort mail rates.

It is still another objective of the invention to provide a drop box collection method for qualified pre-sort mail customers that have over the minimum required volume.

It is another objective of the invention to supply a cost effective method of collecting unqualified pre-sort mail customers' mail and combining these volumes together to meet minimum requirements by the USPS or pre-sort bureaus or companies to receive the pre-sort rates and present the pre-sort mail for processing to a pre-sort bureau or company.

It is another objective of the invention to supply a cost effective method for small courier companies to participate in a drop box system. This is a service they can offer their customers and therefore enhance their operations and further benefit services for their customers by providing more drop off locations and later pickup times.

Additional objects and advantages of the invention will be set forth in part in the description which follows, and in part will be obvious from the description, or may be learned by practice of the invention. The objects and advantages are realized and attained by means of the instrumentalities and combinations particularly pointed out in the appended claims.

### BRIEF SUMMARY OF THE INVENTION

The invention preferably has five primary steps. In the first step the multi-use drop boxes are placed in locations that have been determined to provide the best access to the services offered by the box. The second step involves the collection of the products deposited into the multi-use drop box and sorting these different products into separate containers. In the third step the combined sorted pre-sort mail is delivered to the pre-sort bureau or company's central facility for processing. The fourth step involves the delivery of the sorted courier envelopes and packages to the courier company's central facility. The fifth step involves receiving a payment from both the pre-sort bureau or company and the courier company by a set fee or on a per piece basis for the total number of pieces delivered to each facility.

The method of this invention has benefits to all parties involved. Customers that now cannot participate in pre-sort rate discounts will have a way to receive these discounts. Customers that now can participate in pre-sort rate discounts will be able to use the conveniently located drop boxes instead of having to deliver the qualified pre-sort mail to the post office. The pre-sort bureaus or companies will benefit from this invention by opening up a new market that is currently not being served. This will increase the volume of the pre-sort bureaus or companies that they process and will result in increased revenues for this industry. The small courier companies will have a drop box system that they can cost effectively offer their customers without capital costs having to be invested by the small courier company to build a network or system. The operator of the multi-use drop box system will open a new industry and realize a profit from combining existing separate operations to offer a cost effective method to new markets. And finally, the USPS will benefit from the increase of pre-sorted mail which will decrease its costs and increase its speed and ability to process and deliver the mail.

### BRIEF DESCRIPTION OF THE SEVERAL VIEWS OF THE DRAWINGS

FIG. 1 is an overall flow chart showing operation of the multi-use drop box system.

FIG. 2 represents a multi-use drop box that would be used in the multi-use drop box system.

FIG. 3 illustrates the customers and or products that would be using the multi-use drop box system.

FIG. 4 illustrates a flow chart for qualified and unqualified pre-sort mail use of the multi-use drop box system.

FIG. 5 illustrates the procedures or steps involved with a courier company using the multi-use drop box system for its customers.

FIG. 6 illustrates a flow chart for mail metering service customers using the multi-use drop box system.

FIG. 7 illustrates an example of a sealed envelope to be used for non-metered mail that is deposited in the multi-use drop box system.

FIG. 8 illustrates an example of a common size letter that would be used with the qualified and unqualified pre-sort mail.

FIG. 9 illustrates an example of a courier envelope that would be used and deposited by a courier company and its customers using the multi-use drop box system.

FIG. 10 is a copy of the USPS bulk mail rates applying to pre-sort mail that is available on the USPS web site (www.USPS.com) effective Jun. 30, 2002.

### DETAILED DESCRIPTION OF THE INVENTION

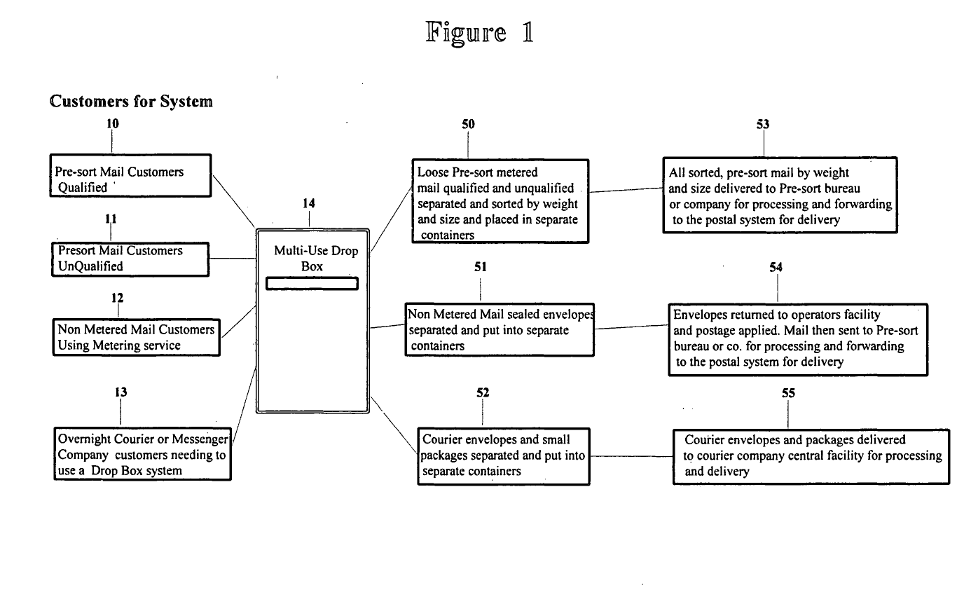

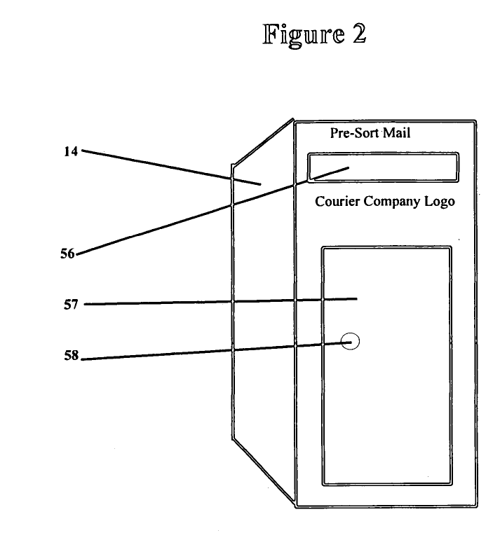

FIG. 1, element 10 is qualified pre-sort mail customers. These customers exceed the minimum volumes to receive the pre-sort mail rates. They also could deposit their letters into the multi-use drop box for collection. These customers currently have to deliver their mail or have it picked up by independent contractors, such as couriers, and deliver it to the USPS or pre-sort bureaus or companies.

FIG. 1, element 11 is unqualified pre-sort mail customers. These customers do not meet the minimum required volumes to receive the pre-sort mail rates. Combining these with other unqualified, as well as qualified customers, will enable them to participate in the discounted rates as the total combined volumes will exceed the minimum required volume.

FIG. 1, element 12 is non-metered mail customers that would use a mailing service. These customers are smaller customers that may not have or want to pay the expense of a postage meter at their business. Instead of paying a monthly lease on a postage meter, and incurring time and money to meter the mail, they can send their mail in a sealed large envelope to the operator of the multi-use drop box system and the operator will meter the mail for a small fee and then submit it to the pre-sort bureau or company for processing.

FIG. 1, element 13 is overnight courier or messenger companies that currently do not have a drop box network and who could use the multi-use drop box system for their customers. The courier envelopes are a different size and have waybills attached so they are easily sorted from the mail and delivered nightly by the operator to a central facility for the courier process. The courier company would pay the multi-use drop box operator a per piece fee for customers using the system.

FIG. 1, element 14 is the multi-use drop box. The box has the ability to receive pre-sort mail as well as courier envelopes and small packages. It has one or more chutes and has a locked secure containment area inside for the products. Customers 10-13 in FIG. 1 are all able to deposit their material into the multi-use drop box.

FIG. 1, element 50 shows the process of separating the qualified and unqualified mail from the courier product and the non-metered mail in sealed envelopes. Once the pre-sort mail is separated it is further sorted by size and weight. For example, all one ounce mail in one ounce mail containers and all two ounce mail in two ounce containers.

FIG. 1, element 51 shows the procedure of separating the non-metered mail in sealed envelopes into separate containers.

FIG. 1, element 52 shows the procedure of separating all the courier envelopes and small packages into separate containers.

FIG. 1, element 53 shows the procedure that after all of the multi-use drop boxes are collected from the multi-use drop box system and the products are individually separated. The combined qualified and unqualified pre-sort mail is delivered to the pre-sort bureau or company. The pre-sort mail bureau or company will then process the mail and compensate the operator of the multi-use drop box a set fee or an amount equal to the total amount based on a per piece basis. The total count or number will be determined by the pre-sort bureau or company. This will be defined by the daily processing report that the pre-sort bureau's or company's sorting equipment will produce for each time it processes the operator of the multi-use drop box system's pre-sort mail collected or delivered to the pre-sort bureau or company.

FIG. 1, element 54 shows the procedure where all of the non-metered mail in sealed envelopes is returned to the operator's facility. The sealed envelopes are then opened and the non-metered mail contained inside is metered with postage and each customer's individual account is charged the total amount of postage plus a fee for applying the postage. The metered mail is then forwarded to the pre-sort bureau or company to be processed and entered into the postal system. The operator of the multi-use drop box system is then compensated on a per piece basis for the amount of mail or letters given to the pre-sort bureau or company. The total count or number will be determined by the pre-sort bureau or company by the daily processing report that the bureau's or company's sorting equipment will supply to the operator of the multi-use drop box system.

FIG. 1, element 55 shows the procedure whereby all of the courier overnight envelopes and small packages are separated from the other products and delivered to the courier company's central facility. The envelopes and small packages are then processed into the courier's system and the operator of the multi-use drop box system is compensated either by a set fee or on a per piece basis for the total number of pieces delivered to the courier company. The total amount will be determined by a pickup manifest listing the total number of pieces collected and will be checked by the courier company and adjusted or agreed upon and signed. This procedure may be done manually or electronically by scanners to determine the total number of envelopes and small packages collected.

Multi-use drop box 14 would be made of either metal, plastic or any other composite material or combination of these materials. It will have one or more openings or chutes 56 to receive letters, envelopes or small packages. It will also contain a space within the box to hold all letters, envelopes or packages mixed together or it could be constructed to separate each as they are received. This would be achieved by each product having a separate chute or opening and also a separate section within the box to hold each separate product. The multi-use drop box will have a single large door 57 which will be locked by lock 58 and will be accessible only by the operator of the multi-use drop box system. This door will be used to open the multi-use drop box and retrieve all of the received or deposited letters, envelopes or small packages. The multi-use drop box may be equipped with conventional electronic devices (not shown) that allow the operator to monitor the box for various operations of the box and its contents. These devices may monitor tampering, theft, unauthorized access, G.P.S. (Global Positional Tracking), contents (either weight, fullness or empty), biological/chemical detection and the ability to lock and unlock access openings or chutes or any other function that the operator of the multi-use drop box would need or desire to oversee the operations of the multi-drop box system.

The multi-use drop box can be labeled to show it will accept pre-sort mail.

The multi-use drop box can also be labeled with the company name or logo of the courier company or companies that would use the multi-use drop box system for its customers. More than one courier company can use each drop box 14.

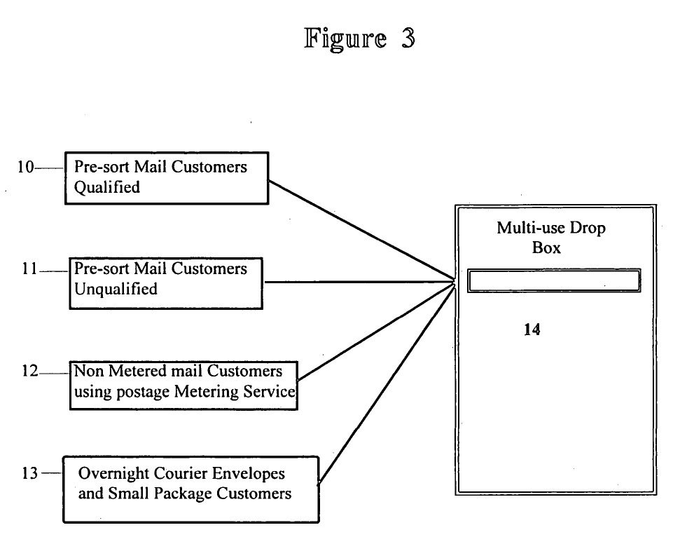

FIG. 3, element 10 represents qualified pre-sort customers. These are customers that qualify for the discounts in postal rates given by the USPS or pre-sort bureaus or companies for mailers typically having more than 500 pieces of pre-sort mail per day.

FIG. 3, element 11 represents unqualified pre-sort mail customers. These are customers that do not qualify for the discount in postal rates given by the USPS. These customers do not meet the daily volumes of mail to receive these discount rates. Combining unqualified customers will allow these customers to receive these discount rates from the pre-sort bureaus or companies.

FIG. 3, element 12 represents non-metered mail customers using a metering service. These are customers that do not have a postage meter or wish to have the operator of the multi-use drop box system meter their mail for them. These customers would set up an account with the operator, put their mail in a sealed envelope and deposit it into a multi-use drop box. The sealed envelopes would be received by the operator of the multi-use-drop box system, opened and the postage would be applied to each letter. The account of the customer would be charged for the postage as well as a fee for the service. The mail would then be delivered to a pre-sort bureau or company for processing and entered into the postal system.

FIG. 3, element 13 represents envelopes and small packages of a courier company's customers that will be deposited into the multi-use drop box system. The operator will contract out the use of the multi-use drop box system to a courier company for use by the courier company's customers. The operator of the multi-use drop box system will collect all of the courier's envelopes and small packages from the multi-use drop boxes and deliver them to a central facility of the courier company daily.

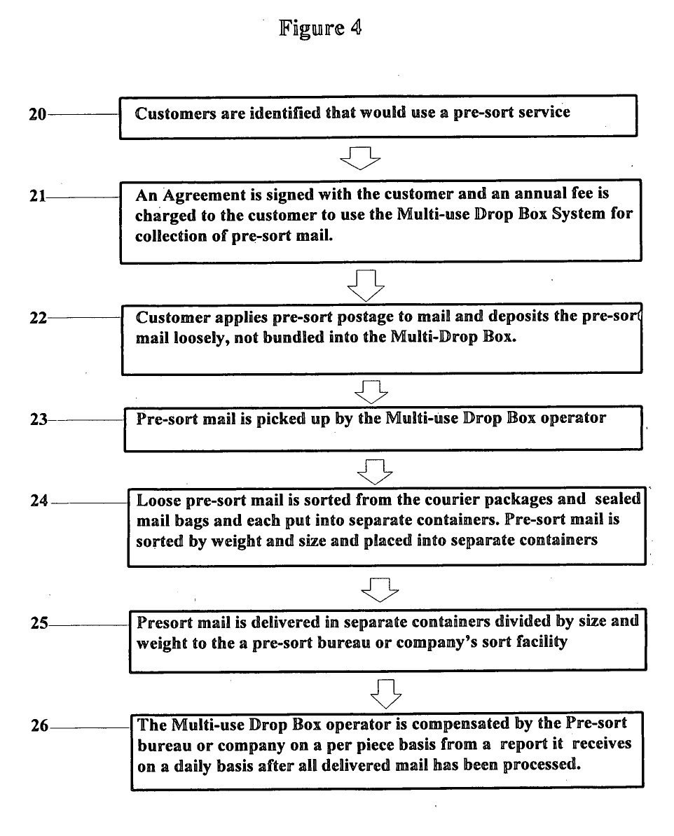

FIG. 4, element 20 illustrates the customers that would use the pre-sort system. These would be any customers that are currently able to qualify for pre-sort mail rates and customers that singularly do not qualify for the discount pre-sort mail rate.

FIG. 4, element 21 illustrates that the customer would enter into an agreement to use the multi-use drop box system. The customer would agree to pay a fee to the operator for the ability to access and use the multi-use drop box system. This would allow the customer to receive the discount pre-sort rates from the USPS by the operator combining all of the qualified and unqualified mail and presenting it to a pre-sort bureau or company for processing and forwarding the mail into the postal system. The customer in signing the agreement would also agree to sign any documents needed by the USPS or the pre-sort bureau or company to receive the postal discount pre-sort rates before they could use the multi-use drop box system. These documents may include a certification of move update compliance letter, a letter to receive drop ship authorization number, a MLOCR processing acknowledgement form, a request to pay postage refunds to the presenter of mail form or any other form that must be signed and filed with the USPS or pre-sort bureau or company.

FIG. 4, element 22 illustrates the customer applying the pre-sort postage rate to their mail and physically placing or depositing the mail loosely into a multi-use drop box.

FIG. 4, element 23 illustrates the mail being picked up from the multi-use drop box by the operator of the multi-use drop box system.

FIG. 4, element 24 illustrates that the operator of the multi-use drop box system opens the multi-use drop box. The pre-sort mail is removed from the box and sorted from the courier envelopes and small packages as well as the sealed non-metered mail envelopes. The pre-sorted qualified and unqualified mail is then sorted according to weight and size of each letter. To illustrate this, all one ounce letters would be placed together and all two ounce letters would be placed together.

FIG. 4, element 25 illustrates that once the pre-sort mail has been combined and sorted it is delivered to the pre-sort bureau or company for processing and entered into the postal system.

FIG. 4, element 26 illustrates the last step of the pre-sort mail multi-use drop box system where the operator is compensated by the pre-sort bureau or company. The pre-sort bureau or company compensates the operator either by a set fee or on a per piece basis for all the pre-sort mail that is presented to the pre-sort bureau or company. This number is determined by a daily report produced by the pre-sort bureau and given to the operator of the multi-use drop box system.

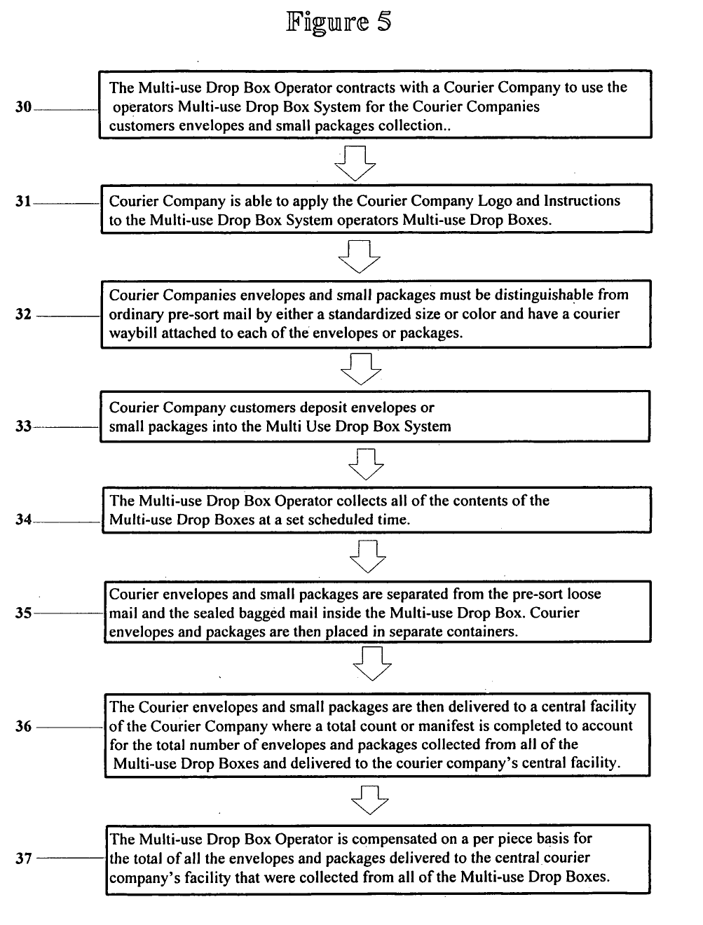

FIG. 5, element 30 shows the courier company entering into an agreement with the operator of the multi-use drop box system to use the multi-use drop box system. This agreement would allow the courier company's customers to use the multi-use drop box system to deposit envelopes and small packages into the multi-use drop boxes agreed to in the agreement. These multi-use drop boxes would be labeled with the courier company's name or logo as well as the operator of the multi-use drop box system.

FIG. 5, element 31 shows a step that allows the courier company to identify contracted multi-use drop boxes with the courier company's name or logo as well as limited space for customer instructions.

FIG. 5, element 32 shows a step which details that the courier company's deposited envelopes and small packages must be distinguishable from ordinary mail letters. This is necessary for the operator to sort the courier envelopes and small packages from the pre-sort mail and non-metered mail in sealed large envelopes. This distinction will be either in size or color or both. A courier waybill will also be attached to the courier envelope or package. An example of this would be a commonly used number ten first class envelope (10.5×24.1 cm) in size referred to as ordinary or normal size mail versus a FedEx® or UPS letter that is typically larger and constructed of heavier material with a courier waybill attached to it.

FIG. 5, element 33 illustrates the courier company's customers depositing envelopes or small packages into a multi-use drop box.

FIG. 5, element 34 illustrates the multi-use drop box system operator collecting all of the pre-sort mail letters, non-metered mail sealed envelopes, courier envelopes and small packages at a preset scheduled time or times each day.

FIG. 5, element 35 illustrates that once all of the pre-sort letters, non-metered mail sealed envelopes and all courier envelopes and packages are removed from the multi-use drop box they are all sorted from each other and the courier envelopes and small packages are separated into separate containers. The number of courier envelopes may be manifested or counted manually or by scanning each piece using a scanning device at time of collection from each multi-use drop box. The total manifested number or scanning will be the number used to compensate the operator of the multi-use drop box system by the courier company.

FIG. 5, element 36 illustrates that the operator of the multi-use drop box system delivers all of the collected courier envelopes and small packages from each multi-use drop box to a central facility of the courier company. At this point a manifest of each piece or number is checked manually or electronically and the total number of envelopes and small packages is agreed to by both parties. That total number is determined to be a number used to compensate the operator of the multi-use drop box system.

FIG. 5, element 37 illustrates the last step of the procedure where the operator of the multi-use drop box system is compensated by the courier company. The courier company pays the operator either a set fee or on a per piece basis for all envelopes and small packages delivered to the courier company's central facility collected from all of the multi-use drop boxes.

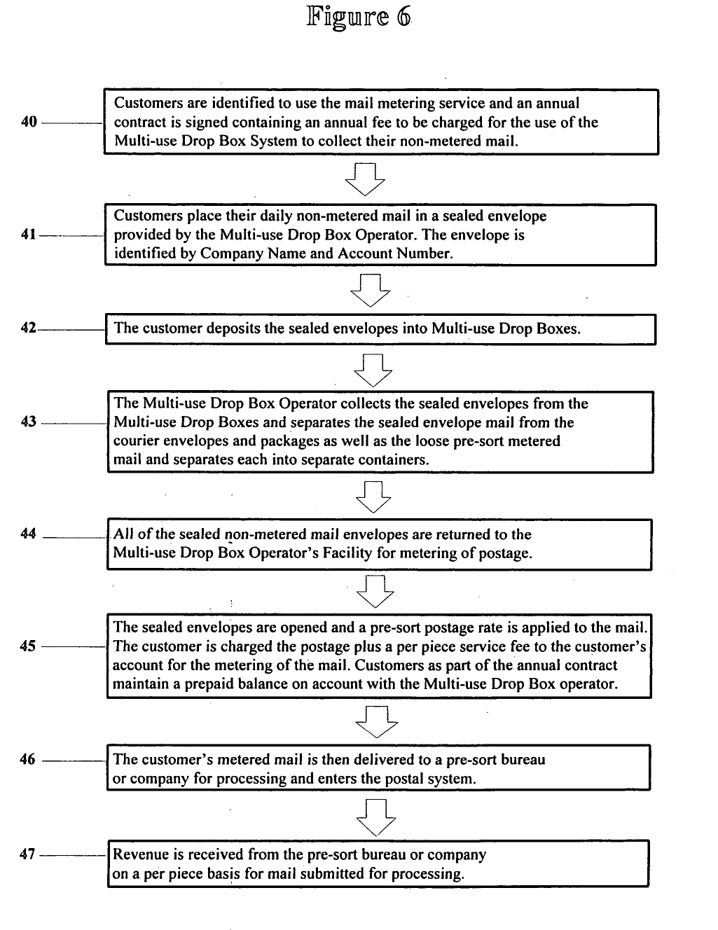

FIG. 6, element 40 represents a step whereby customers that want to use a postage metering service sign an annual contract to use the service and have access to use the multi-use drop box system. Customers prepay postage to the operator of the multi-use drop box system and in return the operator meters their mail and deducts the postage and a fee from their account. The operator then places the mail into the postal system through a pre-sort bureau or company.

FIG. 6, element 41 represents a step that involves the customers placing their daily non-metered mail in a sealed envelope provided by the operator of the multi-use drop box system which is identified by customer name and account number.

FIG. 6, element 42 represents a step that involves the customer depositing the sealed non-metered mail envelope or envelopes into the multi-use drop box.

FIG. 6, element 43 represents a step that involves the operator of the multi-use drop box system collecting all of the letters, sealed non-metered mail envelopes and courier envelopes and small packages from each multi-use drop box and separating all of the sealed non-metered mail envelopes into separate containers.

FIG. 6, element 44 represents a step that involves the operator of the multi-use drop box system returning all of the sealed non-metered envelopes to a central facility to be metered or postage applied.

FIG. 6, element 45 represents a step that involves the sealed envelopes being opened and the postage being applied to the mail contained within the envelope. The customer's account is charged the total cost of the postage plus a service fee to apply the postage. The customer has, per an annual agreement, a balance on account with the operator of the multi-use drop box system and these charges are deducted from that balance.

FIG. 6, element 46 represents a step that involves the customer's metered mail, with the postage applied by the operator, being delivered to a pre-sort bureau or company central facility where it will be processed and entered into the postal system.

FIG. 6, element 47 represents a step that involves the operator of the multi-use drop box system receiving revenue from the pre-sort bureau or company for the pre-sort mail that was delivered to the central facility of the pre-sort bureau or company. The operator of the multi-use drop box system is paid on a per piece basis for all mail delivered for processing to the pre-sort bureau or company's central facility.

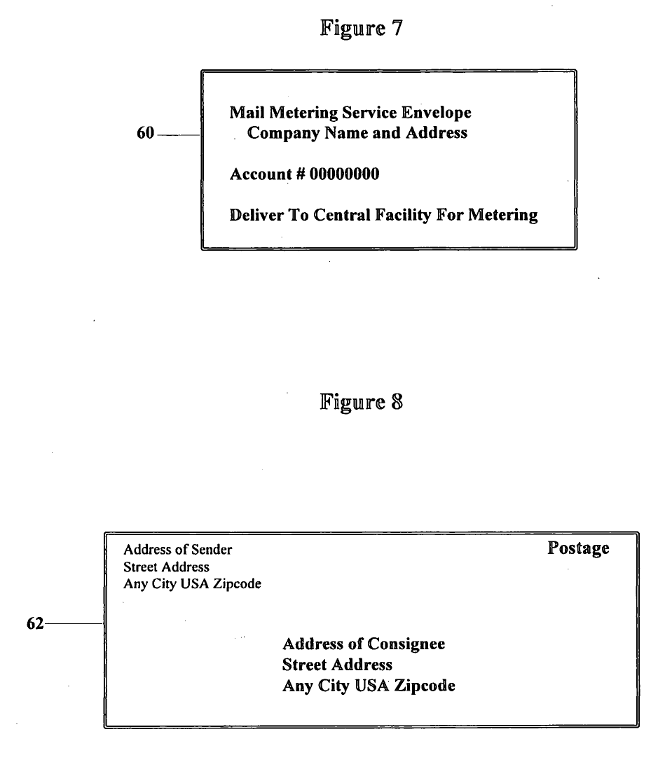

FIG. 7 shows an envelope 60 that will contain the non-metered mail and will be distinguishable from the other contents within the multi-use drop box by size. The envelope will generally be a minimum size of ten inches wide by fourteen inches in height or length. The envelope will also be clearly labeled as a mail metering service envelope or similar terminology. The envelope will have the customer's name and account number clearly visible on the exterior of the envelope. Instructions for delivery of the envelope will also be labeled on the exterior of the envelope.

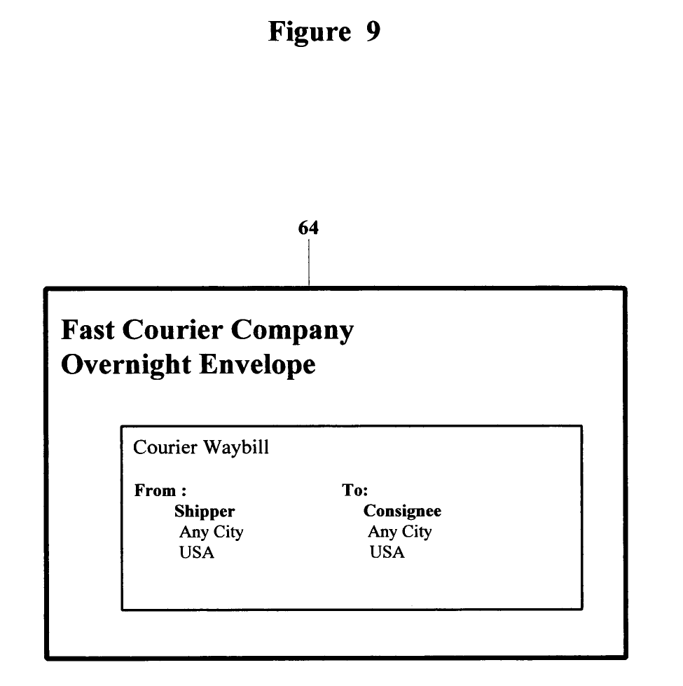

The most common size of envelope 62 using this service is currently known as a number ten size envelope, as shown in FIG. 8. These envelopes would be deposited loosely inside of the multi-use drop box and would differ in size and shape from the envelopes in FIG. 7 and FIG. 9.

The envelope 64 shown in FIG. 9 would be clearly distinguishable from the examples illustrated in FIGS. 7 and 8 and would have a courier waybill attached to the envelope. It would be of a different color or have distinctive markings labeled on the exterior as well as be labeled with the courier company's name or logo. This would allow it to be separated quickly from the other products that will be deposited within the multi-use-drop box.

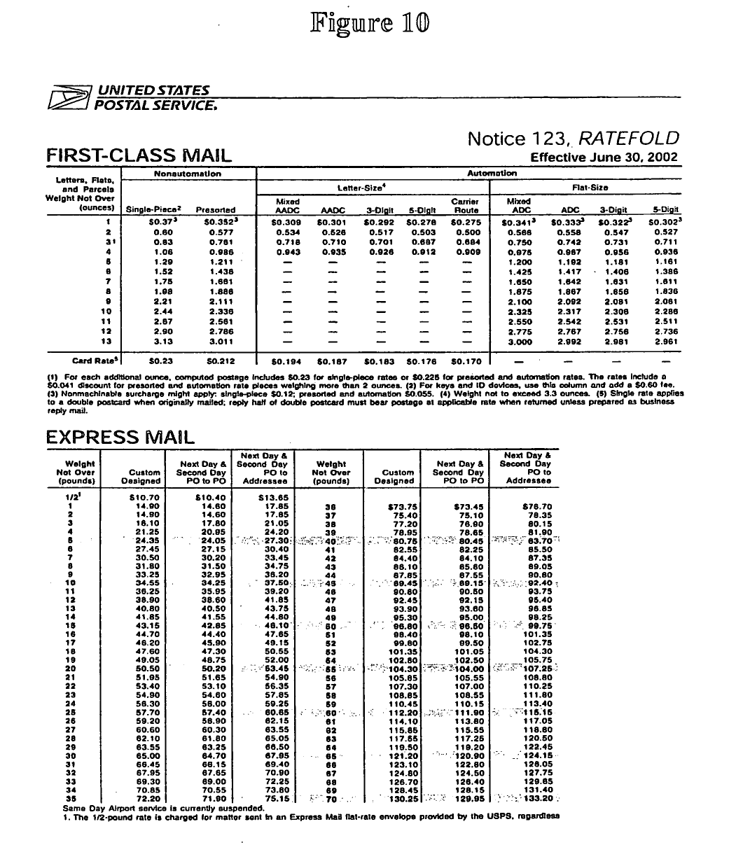

FIG. 10 illustrates the rates that a customer or pre-sort bureau would receive for sorting the mail to a three digit and five digit zip code. This illustrates where the pre-sort bureau or company receives its revenue from sorting the mail as well as compensating the operator of the multi-use drop box system. For example, the customer that would apply the postage would apply it at a rate of $0.352. The difference between the single piece rate and the rate unqualified customers would pay would be the difference between $0.37 and $0.352 which is $0.018. This is the savings that each unqualified customer will be able to save on each piece of first class automated mail that they currently must pay $0.37 per piece for, as they do not qualify by volume to receive this discount. Combining the single unqualified customers will allow them to receive this saving. The pre-sort bureau, for example only, may be able to sort or qualify the total volume of mail down to a five digit sort or by five digits of the zip code, and the refund they would receive would be the difference between the posted rate on the letter of $0.352 and the five digit sort rate of $0.278. The difference of $0.352 less $0.278 would be $0.074 for each letter sorted. From this the pre-sort bureau would pay the operator of the multi-use drop box system and receive its own compensation for processing the pre-sort mail. This is only an example of the revenue as all mail may or may not be qualified to a five digit code and may have other imperfections or incorrect addresses that would not allow the full revenue to be realized. It does show only a simplified example of where the revenue is collected from.

The method and system of this invention is based on the use of a multi-use drop box to combine the services, firstly of a courier drop box to collect courier envelopes and small packages and secondly a mail box to collect pre-sort mail or mail that will be pre-sorted by a pre-sort bureau or company. The method and system also provides for the collection of each product from the multi-use drop box system and delivery to a pre-sort bureau or courier company for the processing of each others products. The invention is unique in that there is no such product or service that allows the depositing of both courier products as well as mail products into one drop box for processing or delivery to consignee. This invention is unique also in that it provides a method of collection of pre-sort mail customers for pre-sort bureaus or companies that are currently not able to service these customers due to the high cost of collecting these smaller volumes. This invention allows the smaller volume customers to be offered discounted mail rates by the pre-sort bureaus or companies, thus opening a huge market that is not currently being served.

This invention is also unique in that it further allows small, local or regional courier companies to compete with national and international courier company drop box systems. The use of the multi-use drop box system allows these smaller courier companies to be able to service their customers with a drop box system. This will open new markets for them as well as save them capital funds that they would have to invest to develop and maintain their own independent drop box system. This invention will allow the smaller courier companies to operate more efficiently as they can have multiple customers drop their envelopes or small packages into a drop box and not have to pickup directly from each customer which they are currently unable to do as time restrains them. The multi-use drop box can allow ten to twenty or more customers to drop their envelopes individually into the multi-use drop box. The courier company currently would have to send an individual courier to each place of business which would be more costly and less effective in time management. If these businesses were all closing at 5 p.m. and the customer wants the latest pickup possible, it is much more effective for each customer to place their outgoing envelopes into a multi-use drop box. They are able to do this as they are currently doing this with envelopes they have for the large national and international courier company drop boxes. Using the multi-use drop box will allow the smaller courier's customers to even have a later drop off time as the collection of the drop boxes occurs at a later time.

This invention is unique in that it combines the operation of a drop box system and a mail box system which allows new markets to be created and serviced that are not currently being served. By splitting the logistic costs between two services this invention allows pre-sort bureaus to open new markets that are not serviced now solely due to the high cost of collecting this mail for processing. This market is not even being serviced with a single mail box service as the logistics costs have prohibited it. The result is that a huge market of small volume mailers cannot receive discounted rates.

The invention provides a system and method for collection of qualified pre-sort mail, unqualified pre-sort mail and non-metered mail to be metered for pre-sort bureaus or companies by using a drop box system. The invention also provides a method or system for small courier companies to collect their envelopes and packages by the use of a drop box system. The invention provides the combining of a courier drop box and a mail box and placing them where they are convenient and accessible for customers, which allows for the ability of pre-sort bureaus and companies to open new markets by having an affordable method of collecting these smaller volumes. It also allows smaller courier companies to open new markets or services that are not currently affordable to operate for these smaller courier companies.

Pre-sort mail rates are offered by the USPS to mailers that have bulk mail and that are able to sort their mail to a single area or portion defined by a zip code or part of the zip code. The primary zip code is made up of a five digit number. Each digit on the zip code from the fifth to the first number defines a region, state or area down to a street or carrier route. Businesses that are able to pre-sort their mail by these zip codes are given a discount as it saves the USPS time and money as this mail requires less handling and sorting by the USPS. Due to the sorting requirements, these companies must have large volumes to make this feasible for companies to pre-sort large volumes of mail and realize any savings. This has opened a new business in the private sector called pre-sort bureaus or companies that combine large volumes of mail from separate companies. This mail is then pre-sorted and presented to the USPS in a pre-sort condition for future processing or to final destination for delivery. The pre-sorted bureau or company then receives a discount back or fee for sorting this mail. This has been a growing segment in the mail industry and more and more companies are using pre-sort bureaus or companies to process their mail for them as they can receive a discount and do not have to manually or mechanically incur the cost of sorting this mail.

The pre-sort bureaus or companies maintain mail sorting equipment that is able to read, process and sort the mail to required standards set out by the USPS. The pre-sort bureaus or companies receive the mail either by maintaining a fleet of vehicles or by paying a transport company to pick up volumes of mail from customers that they sort mail for. Due to the cost of this pickup procedure, the pre-sort bureaus or companies must require these companies to maintain high volumes to compensate for the costs incurred in the collection of their mail. Commonly, these bureaus or companies require a minimum number of mail pieces of one thousand pieces per day or more. This number may vary a few hundred but is a very real number that the pre-sort bureaus need to maintain a profit.

The pre-sort bureau is able to offer the customer the ability to meter or apply a discount rate to their mail as they will pre-sort the mail for them and combine their mail with other customers and receive a further or greater discount, which is the amount that they receive and operate on.

For example, the pre-sort house will allow the customer to apply a postage rate of $0.352 to each letter instead of $0.37 per letter (as per FIG. 10). The customer receives a $0.018 saving on each letter metered and submitted to the pre-sort bureau or company. The pre-sort company combines a large number of companies' mail together and sorts it to as fine a zip code or three to five digit sorting. For example, again from FIG. 10, we will use the five digit pre-sort rate of $0.278 level that they sort the mail to. In reality all mail would not be sorted to this rate as some mail would be sorted to a three digit rate and a blended discount (part $0.292 & part $0.278) would be received by the pre-sort bureau or company. However, for this example we will use the five digit rate. The pre-sort bureau or company would receive back from the USPS the difference between the posted rate of $0.352 and the five digit rate of $0.278 equal to $0.074 per letter. From this revenue they deduct their costs and determine their profit.

The pre-sort bureaus or companies have developed a new industry by combining a collection of volume mailers and pre-sorting their mail together and then entering it into the postal system. This has been a more effective way for the post office to process or pre-sort incoming mail as it is already sorted and requires much less handling which means reduced costs and speeds up the delivery time for the mail which is an added benefit to the customer.

These pre-sort bureaus or companies have, however, been only able to service large mailers with an average of one thousand pieces of mail per day. This requirement for a set or average volume has made it impossible for these pre-sort bureaus or companies to offer their services to smaller every day businesses. They do not have a viable cost effective method for collecting and combining these smaller mailers so that they can open up this new market and pass these pre-sort discounts on to this large untapped market.

This invention is able to give these pre-sort bureaus or companies the ability to open these new markets. This will increase the pre-sorts' revenues therefore increasing the industry's ability to grow and develop. This invention will create a new business for the operators of these multi-use drop boxes. This invention will save every small business or individual money in postage costs by opening up these discounts to the smaller mailers. The invention will speed up the delivery time for the mail resulting in a more efficient postal system. Finally, this invention will save the USPS more money and time in that it allows a greater amount of mail to be pre-sorted than is currently entering the postal system.

This invention further improves the current efficiency of the pre-sort bureau in that it allows current customers that they are collecting mail from to use the multi-use drop box system for depositing their mail. The pre-sort bureau or company can reduce its cost of picking up these letters by simply having the customer place them into a local multi-use drop box. This eliminates the requirement for a vehicle to go directly to the customer. Multiple customers could use the same multi-use drop box, thus saving the pre-sort bureau or company time and money.

The customers that this invention of the multi-use drop box can service are qualified pre-sort customers, the unqualified customers, customers wishing to have their mail metered as well as pre-sorted (non-metered mail) and courier companies that want to have a complete drop box system for the collection of their customers' courier envelopes and small packages.

Qualified pre-sort customers, FIG. 1, element 10 represents customers that currently have a large enough volume to qualify for a pre-sort mail rate. These are current customers that are able to use the pre-sort bureaus to receive a discounted rate. This mail is currently picked up by an individual delivery method or transport at a set time. This does not allow for any flexibility in the pickup time as these collections must be made with other collections and therefore must be performed in a timely manner. The invention allows the customer to use the multi-use drop box at the customer's convenience as it allows for a more efficient method of collection as the letters are collected from one location, the multi-use drop box, instead of multiple locations such as the customers' individual locations. This efficiency is illustrated by the use of drop boxes by large international courier companies such as FedEx® and UPS®.

Unqualified pre-sort customers, FIG. 1, element 11, are customers that are currently unable to receive a pre-sort mail discount by using a pre-sort bureau or company. They are unable to use a pre-sort bureau as the pre-sort bureau or company currently has no way to cost effectively collect and combine these smaller volumes to process them for a discount. The invention of the multi-use drop box opens a new market and allows a pre-sort bureau or company to offer these discount rates to this new potential market.

Non-metered mail customers using a metering service, FIG. 1, element 12, are customers who want to use a mail house or service that both meters their mail as well as uses a pre-sort bureau. This saves the customer the time and money associated with owning and operating a postage meter at their place of business. The customer can simply put all outgoing mail in a sealed envelope and deposit it into the multi-use drop box. These envelopes are clearly identifiable and are separated by the operator of the multi-use drop box. The mail is metered and given to the pre-sort bureau or company for a fee.

This invention allows smaller courier or messenger companies, FIG. 1, element 13, to access a complete drop box system for their customers use at a fraction of the cost. Large courier companies that are national or international use the drop box system to reduce their costs and increase their efficiency. Smaller courier companies must set up their own drop box system as well as maintain it and bear all of the costs associated with the system on their own. The multi-use drop box splits the costs between courier and mail collection which would allow the smaller courier companies to operate a drop box system that is currently too expensive to operate independently. This opens a new market for these small courier companies and services their customers with later cut-off times and more options to increase their own company's efficiencies.

The operator is the individual or company that operates the multi-use drop box system. The operator is primarily, but not limited to two customers, the pre-sort bureaus or companies that require a collection system for pre-sort mail and the small courier companies that require a drop box system for their customers.

The operator will enter into an agreement with a pre-sort bureau or company and a local small courier company to operate a multi-use drop box system. The operator will be compensated either by a set fee or on a per piece fee to operate and maintain the multi-use drop box system.

The operator will place, at the request of the pre-sort bureau or company and the courier company, multi-use drop boxes at locations that are determined to be convenient or accessible for each party's customers. These could be inside office buildings, outside office buildings or any public or private location that is determined to be accessible for the customer.

The operator will pay any leases, rents or insurance associated with the placing of the multi-use drop box. The operator may operate the multi-use drop box by either hired employees, by sub-contracting the operations or by franchising the operations.

The operator will monitor and maintain each multi-use drop box with the multi-use drop box system. This monitoring could be done physically or by electronic monitoring devices.

The operator will collect from each multi-use drop box all of the deposited contents at a set time or schedule, daily or otherwise agreed upon, but posted on the multi-use drop box for the customers' information.

The operator will, for the pre-sort bureau or company, collect all pre-sort mail deposited into the multi-use drop box system. The operator will then combine and sort according to weight and size all of the collected pre-sort mail. Once all of pre-sort mail is collected, sorted and combined it will then be delivered to a central facility of the pre-sort bureau or company for processing and entered into the postal system. The operator will be compensated for the total number of pre-sort mail letters delivered to the central facility either by a set fee or on a per piece basis.

The operator will, for the non-metered mail in sealed envelopes, collect all of the sealed envelopes and either meter the mail at the operator's facility or deliver the mail to the pre-sort bureau or company for metering and processing. If the mail is metered at the operator's facility, the metered mail will then be sorted by weight and size and delivered to the pre-sort bureau or company's central facility for processing and entered into the postal system. The operator will then be compensated for the total number of pre-sort mail letters delivered to the pre-sort bureau or company either by a set fee or on a per piece basis.

The operator will, for the courier company or companies, collect from all of the multi-use drop boxes in the multi-use drop box system, all of the deposited courier envelopes and small packages. The operator will, after collecting all of these courier envelopes and small packages, deliver them to a central facility of the courier company. The courier envelopes and small packages will be manifested either manually or electronically to determine the total number of envelopes and packages delivered to the courier company's central facility. The operator will be compensated by the courier company for the total number of envelopes and packages delivered to the central facility either for a set fee or on a per piece basis.

This invention provides a system and method that includes existing qualified pre-sort mail customers, a new market of unqualified pre-sort mail customers, the collection of courier envelopes and small packages, the use of a multi-use drop box to deposit each letter, envelope and package into and an operator maintaining a collection method from these multi-use drop boxes to combine, sort and deliver each letter, envelope or small package for processing to a central facility for each product to be processed. This invention allows new markets to be opened and provides numerous cost savings and efficiencies to the customer, pre-sort bureaus or companies, the USPS as well as small courier companies. This invention also creates a new industry by combining the operations of a courier drop box system and a mail collection box system into a multi-use drop box system that combines the services of both. This creates a cost effective method or system to open new markets for pre-sort bureaus or companies and small courier companies.

The system and method of this invention could also be modified to include other classes of mail that the pre-sort bureaus or companies may want to process with the efficiency of this invention.

This invention could also be modified to include other courier products or materials that courier companies may want to process or collect using this method or system.

The invention in its broader aspects is not limited to the specific details shown and described, and departures may be made from such details without departing from the principles of the invention and without sacrificing its chief advantages.

1. A method for collecting and processing products, including mail, courier envelopes and courier packages comprising the steps of:
an operator placing drop boxes in predetermined locations;
customers depositing said products, including unqualified and qualified pre-sort mail and courier envelopes and courier packages into said drop boxes;
said operator collecting said products from said drop boxes;
said operator sorting said products;
said operator delivering said unqualified and said qualified pre-sort mail to a pre-sort mail facility of a pre-sort mail entity for processing by said entity;
said operator delivering said courier envelopes and said courier packages to a courier's facility for processing by said courier; and
said pre-sort mail entity and said courier making payments to said operator.

2. A method as in claim 1 further including the step of said customers making payments to said operator for the privilege of using said drop boxes.

3. A method as in claim 2 wherein said unqualified pre-sort mail is mail that cannot receive a discounted pre-sort postage rate from the U.S. postal service.

4. A method as in claim 3 wherein said qualified pre-sort mail is mail that can receive a discounted pre-sort postage rate from the U.S. postal service.

5. A method as in claim 4 wherein said customers depositing said unqualified pre-sort mail into said drop boxes apply appropriate pre-sort postage to said unqualified pre-sort mail before depositing said unqualified pre-sort mail into said drop boxes.

6. A method as in claim 5 wherein said customers depositing said unqualified pre-sort mail into said drop boxes must deposit said unqualified pre-sort mail loosely and not bundled into said drop boxes.

7. A method as in claim 6 wherein said unqualified pre-sort mail is mail that includes less than a predetermined number of mail pieces as determined by the U.S. postal system.

8. A method as in claim 7 wherein said qualified pre-sort mail is mail that includes a number of mail pieces equal to or greater than a predetermined number of mail pieces as determined by the U.S. postal service.

9. A method as in claim 8 further including the steps of said courier providing said courier's customers with standardized envelopes and packages distinguishable from mail by size or color and said courier attaching said courier's waybill to said standardized envelopes and packages.

10. A method as in claim 9 wherein said products include non-metered mail in sealed envelopes deposited into said drop boxes by non-metered mail customers.

11. A method as in claim 10 wherein said qualified and unqualified pre-sort mail is combined and sorted by said operator by weight and size of envelopes into first separate containers.

12. A method as in claim 11 wherein said courier envelopes and packages are sorted by said operator into second separate containers.

13. A method as in claim 12 wherein said non-metered mail in sealed envelopes is sorted by said operator into third containers.

14. A method as in claim 13 wherein all said courier envelopes and all said courier packages are delivered nightly to said courier's facility by said operator.

15. A method as in claim 14 wherein all said sealed envelopes containing said non-metered mail are transported to said operator's facility, said non-metered mail is then metered by said operator and delivered to said pre-sort mail facility.

16. A method as in claim 15 wherein said payments made by said pre-sort mail entity to said operator are determined by a first predetermined fee or on a per piece basis for all mail delivered by said operator to said pre-sort mail entity.

17. A method as in claim 16 wherein said payments made by said courier to said operator are determined by a second predetermined fee or on a per piece basis for the total number of said courier's envelopes and said courier's packages delivered by said operator to said courier.

18. A method as in claim 17 wherein said non-metered mail customer makes payments to said operator.

19. A method as in claim 18 wherein said payments by each of said non-metered mail customers to said operator are determined on a per piece basis for each piece of mail metered for said customer by said operator.

20. A method as in claim 19 wherein each of said customers makes payment to said operator for use of said drop boxes.
